(19) United States
(12) Patent Application Publication
(10) Pub. No.: US 2025/0383451 A1
(43) Pub. Date: Dec. 18, 2025

(54) DETECTOR FOR GNSS SPOOFING USING AUXILIARY SENSORS

(71) Applicants: Birendra Kujur, Chicago, IL (US); Samer KHANAFSEH, Tinley Park, IL (US); Boris Steven PERVAN, Chicago, IL (US)

(72) Inventors: Birendra Kujur, Chicago, IL (US); Samer KHANAFSEH, Tinley Park, IL (US); Boris Steven PERVAN, Chicago, IL (US)

(73) Assignee: ILLINOIS INSTITUTE OF TECHNOLOGY, CHICAGO, IL (US)

(21) Appl. No.: 19/233,149

(22) Filed: Jun. 10, 2025

Related U.S. Application Data
(60) Provisional application No. 63/661,457, filed on Jun. 18, 2024.

(51) Int. Cl. G01S 19/21; G01S 19/31

(52) U.S. Cl. CPC G01S 19/215; G01S 19/31

(57) ABSTRACT

A system and method for detecting Global Navigation Satellite System (GNSS) spoofing, through monitoring for tracking errors in GNSS signals during movement by comparing each of a plurality of the GNSS signals to a corresponding measurement from an auxiliary sensor, and determining accumulating discrepancies between the plurality of GNSS signals and the corresponding measurements from the auxiliary sensor. An optimal test statistic checks for discrepancies between the GNSS signals and measurements from the auxiliary sensor.

### CROSS REFERENCE TO RELATED APPLICATION

This application claims the benefit of U.S. Provisional Patent Application Ser. No. 63/661,457, filed on 18 Jun. 2024. The co-pending parent application is hereby incorporated by reference herein in its entirety and is made a part hereof, including but not limited to those portions which specifically appear hereinafter.

### STATEMENT REGARDING FEDERALLY SPONSORED RESEARCH

This invention was made with government support under FA8650-22-C-1126 awarded by Airforce Research Lab (AFRL), MOA693KA8-21-T-00027 by Federal Aviation Administration (FAA) and 69A3552348324 by Department of Transportation (DOT) Carnations. The government has certain rights in the invention.

### FIELD OF THE INVENTION

This invention relates generally to a method and a system for detecting Global Navigation Satellite System (GNSS) spoofing and more specifically, for detection of the spoofing at an early stage, utilizing an auxiliary sensor (AS).

### BACKGROUND OF THE INVENTION

The civil infrastructures behind safety-critical applications in aviation, maritime, and terrestrial navigation rely heavily on global navigation satellite systems (GNSSs). The civil GNSS signal structures are publicly known and vulnerable to spoofing attacks, which endangers public safety. In an attack, the spoofer feeds a counterfeit signal to the targeted user to cause faulty position or time estimates. Spoofing signals can be created in several ways, for example, by transmitting self-consistent synthetic GNSS signals using a GNSS simulator, by meaconing (i.e., recording authentic GNSS signals and rebroadcasting them with a delay), or by recording and replaying authentic signals with altered navigation data, among others.

Spoofed signals can be sent to target receivers via a single transmit antenna or an array of multiple antennas, static or mobile, to mimic the satellite line-of-sight geometries. A spoofer may choose to initially send the counterfeit signals at a lower power than the authentic signals and then slowly increase the power to cause the target receiver's tracking loops to transition from the authentic to the spoofed signals and to then slowly drag the user along a false trajectory. A spoofer can also opt to jam the GNSS signals before transmitting the spoofed signal. A more sophisticated spoofer could send two spoofed signals, where one of the spoofed signals would be in opposite phase to the authentic signals, causing cancellation. In this process, known as nulling, the target receiver would not even be able to detect multiple correlation peaks. Ideally, spoofing detection techniques should protect against all possible scenarios.

Potential detection techniques include signal-processing methods, such as power and distortion monitoring, cryptographic authentication, correlation comparison with encrypted authentic signals, correlation peak comparison within a receiver, combining different observables, use of multiple receivers, spoofing discrimination using spatial processing by antenna arrays, GNSS signal direction of arrival comparison, code and phase rate consistency checks, high-frequency antenna motion, automatic gain control schemes, and signal power monitoring techniques. Some of these methods are indeed effective, but they have various computational, logistical, and physical limitations. Augmenting data from auxiliary sensors such as inertial measurement units (IMUs), barometric altimeters, and independent radar sensors to discriminate spoofing has also been proposed before.

An IMU is naturally immune to external interference, which makes it an excellent resource for ensuring navigation continuity. Additionally, when used in the navigation solution in various integration schemes with GNSS (uncoupled or loosely, tightly, or ultra-tightly coupled), the INS provides the redundancy needed to resist spoofing attacks. A chi-squared innovation sequence detector is developed to monitor the accumulated time history of normalized Kalman filter (KF) innovations. The two main advantages of this cumulative innovation (CI) sequence monitor are that innovations are already available in the KF, such that little additional computation is required for the monitor implementation, and that it provides detection capability against slowly growing faults.

However, post-detection recovery has not been addressed in current technology; the difficulty being that the KF is already corrupted once spoofing is detected. Moreover, previous performance evaluations assumed that the CI monitor started at spoofing onset and operated without a defined run time. Furthermore, the CI monitor did not provide the means to produce a protection level, i.e., a position-domain containment boundary corresponding to the maximum acceptable level of integrity risk. To address these critical limitations, a cumulative position-domain innovation (CPI) monitor that detects spoofing by accumulating the target position tracking error embedded in the spoofer's signal and a method to produce both protection levels and post-detection recovery is highly desired.

### SUMMARY OF THE INVENTION

A general object of the invention is to detect global navigation satellite system (GNSS) spoofing using an auxiliary sensor (AS), for example, an inertial navigation system. Various embodiments are described herein, including devices, systems, components, apparatuses, methods, procedures, instructions, code, computer readable/storage medium, and the like.

The invention includes a method for detecting Global Navigation Satellite System (GNSS) spoofing, via monitoring for tracking errors in GNSS signals during movement by comparing each of a plurality of the GNSS signals to a corresponding measurement from one or more auxiliary sensors, and determining accumulating discrepancies between the plurality of GNSS signals and the corresponding measurements from the auxiliary sensor.

Embodiments include computing an optimal test statistic to check for discrepancies between the GNSS signals and the measurements from the AS. Embodiments also include accumulating the discrepancies between the received GNSS signals and the measurements from the AS. Embodiments may also include generating an alarm upon reaching a predetermined threshold of the accumulated discrepancies between the received GNSS signals and the measurements from the AS. Embodiments may also include determining the GNSS spoofing when such alarm may be generated.

In some embodiments, the auxiliary sensor (AS) may be selected from the group consisting of an inertial sensor, Lidar, an odometer, a vision or optical sensor, an ultra-wideband (UWB) sensor, an external clock, or combinations thereof. In some embodiments, the method includes providing position domain protection levels during the detection process. Embodiments may also include providing position domain protection levels, which includes setting a specific window length to achieve desired missed detection probabilities and implementing a solution separation of integrated GNSS/AS solution and AS-only solution over the specific window length.

In embodiments, the specific window length further generates a sequence of overlapped windows. In some embodiments, a solution separation monitor may be started inside the sequence of overlapped windows to provide position domain protection levels. In embodiments, the method includes providing post detection exclusion to ensure continuity of the navigation function. In embodiments, the optimal test statistic is a Neyman-Pearson optimal test statistic. Embodiments may also include accumulating the discrepancies utilizes accumulated Kalman filter innovations projected into the position state domain.

In embodiments, each of the plurality of the GNSS signals are validated until at least one discrepancy is determined between the plurality of GNSS signals and the corresponding measurements from the auxiliary sensor. Upon validating a GNSS signal, a monitoring window having a predetermined timeframe is implemented for a next of the plurality of the GNSS signals. A window length can be set as a function of predetermined missed detection probabilities. A solution separation can be implemented between integrated GNSS-and-auxiliary-sensor solutions and auxiliary-sensor-only solutions over the window length. In embodiments, sequences of overlapping windows are set, and a solution separation monitor is applied to overlapping windows to determine the accumulating discrepancies.

The invention further includes a method for detecting Global Navigation Satellite System (GNSS) spoofing, including the steps of: receiving GNSS signals; acquiring measurements from at least one auxiliary sensor; comparing a plurality of the GNSS signals with corresponding measurements from the at least one auxiliary sensor; applying an optimal test statistic (e.g., a Neyman-Pearson optimal test statistic) to determine discrepancies between the GNSS signals and the measurements from the auxiliary sensor; and generating an alarm for possible GNSS spoofing upon reaching a predetermined threshold of accumulated discrepancies between the GNSS signals and the measurements from the auxiliary sensor. In embodiments, the method includes applying a predetermined monitoring window to each of the plurality of GNSS signals, providing position domain protection levels of a specific window length to achieve desired missed detection probabilities, and implementing a solution separation between integrated GNSS-and-auxiliary-sensor solutions and auxiliary-sensor-only solutions over the specific window length. The specific window length generates a sequence of overlapped windows, and the solution separation begins inside the sequence of overlapped windows to provide the position domain protection levels. Accumulating the discrepancies desirably utilizes accumulated Kalman filter innovations projected into the position state domain.

Embodiments of the present disclosure include a computational system for detecting GNSS spoofing, including one or a plurality of GNSS receivers configured to receive GNSS signals. Embodiments include one or a plurality of auxiliary sensors (AS) configured to acquire measurements. Embodiments also include one or a plurality of processors configured to compute an optimal test statistic based on comparing between the GNSS signals with the measurements from the AS. Embodiments may also include one or a plurality of processors configured to determine whether the GNSS signal may be a spoofing signal based on the whether the accumulated discrepancies of between the received GNSS signals and the measurements from the AS exceeds a predetermined threshold.

The computational system desirably provides position domain protection levels during the detection process. The computational system can provide post detection exclusion to ensure continuity of the navigation function. In some embodiments, the computational system includes an optimal monitor derived to detect anomalous temporal structures in the received GNSS signals caused by spoofer's target tracking errors.

In embodiments, the processors utilize accumulated Kalman filter innovations projected into the position state domain for monitoring. In some embodiments, the computational system may include means for adjusting the monitor window length to achieve desired missed detection probabilities. In some embodiments, the computational system may include an evaluation module configured to evaluate the performance of the monitor for both white and colored tracking error.

The computational system can include a solution separation module configured to detect rapid-onset spoofing and to achieve protection levels in real time. In embodiments, the auxiliary sensor (AS) may be selected from the group consisting of an inertial sensor, Lidar, an odometer, a vision or optical sensor, an ultra-wideband (UWB) sensor, an external clock, or combinations thereof. Embodiments may also include a computer readable medium/device including the computational system.

The invention further includes a computational system for detecting GNSS spoofing, including a module for receiving GNSS signals and auxiliary sensor measurement signals; at least one processor configured to compute an optimal test statistic based on comparing the GNSS signals with the auxiliary sensor measurement signals, and at least one processor configured to determine whether the GNSS signal is a spoofing signal based upon accumulated discrepancies between the GNSS signals and the auxiliary sensor measurement signals exceeding a predetermined threshold. The invention desirably provides position domain protection levels during the detection process, and/or post detection exclusion to ensure continuity of the navigation function. A solution separation module can be configured to detect rapid-onset spoofing achieve protection levels in real time. The processors utilize accumulated Kalman filter innovations projected into the position state domain for monitoring.

### BRIEF DESCRIPTION OF THE FIGURES

FIG. 1 is a flowchart illustrating a method for detecting Global Navigation Satellite System spoofing, according to embodiments of the invention.

FIG. 2 illustrates an example of a solution separation (SS) sequential monitor windows with increasing protection level (PL), according to some embodiments of the invention.

FIG. 3 illustrates the minimum detection window (Nₘᵢₙ) versus tracking error magnitude for an example satellite geometry, according to embodiments of the invention.

FIG. 4 illustrates the maximum protection level (PL) versus tracking error magnitude for an example satellite geometry, according to embodiments of the invention.

### DETAILED DESCRIPTION

Embodiments of the invention include a system and a method for detecting Global Navigation Satellite System (GNSS) spoofing, including the steps of receiving one or a plurality of GNSS signals. Embodiments may also include acquiring measurements from one or a plurality of auxiliary sensors (AS). Embodiments include comparing the GNSS signals with the measurements from the AS, to determine or identify a spoofed signal. Upon such determination an alert can be issued that the GNSS system is no longer trustworthy and/or the GNSS geolocation system can be automatically shut off or otherwise ignored to avoid further course deviation.

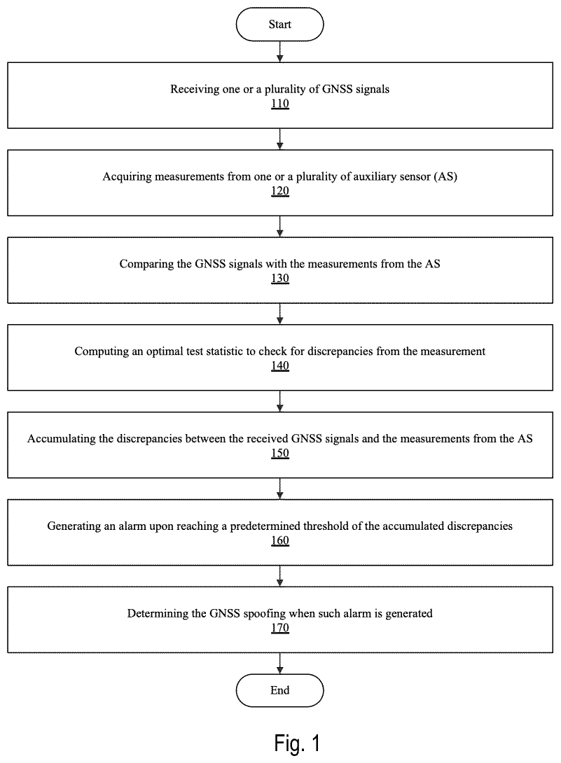

FIG. 1 is a flowchart that describes a method for monitoring Global Navigation Satellite System (GNSS) signals for spoofed signals, according to embodiments of the present disclosure. At 110, the method includes receiving one or a plurality of GNSS signals. At 120, the method includes acquiring measurements from one or a plurality of auxiliary sensors (AS). The AS may be any suitable sensor(s), and any corresponding processing system, for use in determining position, such as, without limitation, one or more of an inertial sensor (INS), Lidar, an odometer, a vision or optical sensor, an ultra-wideband (UWB) sensor, or an external clock. At 130, the method includes comparing the GNSS signals with the measurements from the AS. At 140, the method includes computing an optimal test statistic to check for discrepancies between the GNSS signals and the measurements from the AS.

At 150, the method includes accumulating the discrepancies between the received GNSS signals and the measurements from the AS. At 160, the method includes generating an alarm upon reaching a predetermined threshold of the accumulated discrepancies between the received GNSS signals and the measurements from the AS. At 170, the method includes determining the GNSS spoofing when such alarm may be generated.

In embodiments, the method includes providing position domain protection levels during the detection process. In embodiments, providing position domain protection levels includes setting a specific window length to achieve desired missed detection probabilities and implementing a solution separation of integrated GNSS/AS solution and AS-only solution over the specific window length.

The specific window length may further generate sequence of overlapped windows. A solution separation monitor may be started inside the sequence of overlapped windows to provide position domain protection levels. In embodiments, the method includes providing post detection exclusion to ensure continuity of the navigation function. In embodiments, the optimal test statistic may be Neyman-Pearson optimal test statistic. In some embodiments, accumulating the discrepancies utilizes accumulated Kalman filter innovations projected into the position state domain. The Neyman-Pearson optimal test statistic can be used to maximize the probability of detection for a given false alarm rate.

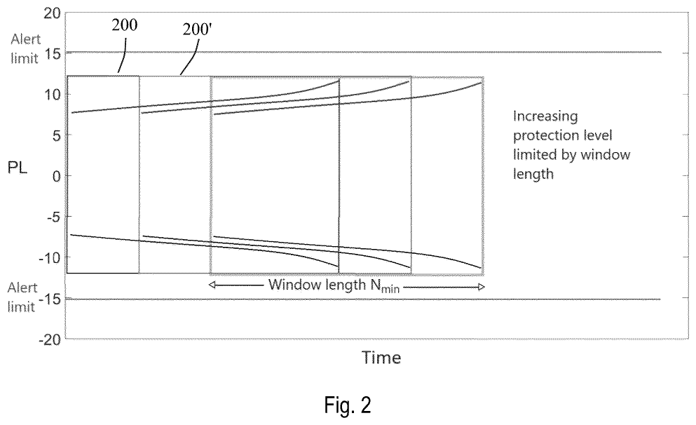

FIG. 2, discussed further below, shows an example of solution separation (SS) sequential monitor windows, according to embodiments of the invention. The x-axis represents the protection level (PL), which can be generally understood as a position-domain containment boundary corresponding to or predetermined by the maximum acceptable level of integrity risk. Running detection windows at a predetermined time length (e.g., 10, 20, 30 seconds, etc.) is used to monitor for spoofed signals. Each received GNSS signal is validated, and upon validating a monitoring window 200 is implemented, having the predetermined timeframe for the next GNSS signal. The window length can be set as a function of predetermined missed detection probabilities, and a solution separation can be implemented between integrated GNSS-and-auxiliary-sensor solutions and auxiliary-sensor-only solutions over the window length. At the next GNSS signal, the validation is repeated, and a new window 200′ is introduced. The validation uses the AS information, and there is an expected distribution of validated signals over time.

The lines at 15 and −15 represent an exemplary alert limit. The GNSS signals need to be within the alert limit, relative to the last signal or window. At any given instance of time there will be a set number of monitor windows running. The false alert requirement allocation for each monitor can be equally divided among these monitor windows to determine the thresholds for each. If the test statistic exceeds the solution separation threshold, then a spoofing attack is flagged or alarm triggered. In embodiments, the protection level represents a stochastic bound on the position error (that is typically required in safety critical systems), and the alert limit is how much error the system can tolerate. As an example, if PL>AL then the mission can be adjusted or called off (e.g., if it is a landing approach, it will be called off and a turnaround is commanded). The alert indicates that the navigation system does not meet safety requirements, and the pilot should revert to either an alternative sensor or leave the strict requirement space (landing approach for instance), etc.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Example 1: Cumulative Position Domain Innovation Monitor

### 1.1 Spoofer's Tracking Error

The smart spoofer's initial objective is to cause the target receiver to lose lock of the authentic GNSS signals and lock onto the counterfeit signals without being detected. This initial lock transition is crucial because any abrupt changes during the process would be easily detectable, sabotaging the spoofer's plan. The best way for a spoofer to influence the target to switch the counterfeit signal without being detected is to initially replicate the authentic signals at lower power and then slowly increase power to cause the target receiver to transition. If successful, the spoofer would then attempt to inject small but accumulating position and/or time offsets to attempt to slowly pull the target away along the desired spoofed trajectory while remaining undetected.

In order to deliver a replica of the authentic signal to the target, the spoofer would need to know the position of the target's GNSS antenna during the attempted takeover. This means that the spoofer would need to track the target in real time. Any tracking errors would ultimately be embedded in the replica signal and appear to the target as additional ‘noise’ in the received GNSS signals. As tracking errors are inevitable, detecting the presence of such unusual noise would expose active spoofing. This would be true even during the initial takeover phase when the spoofer has not yet injected any additional offsets to the spoofed signals. Below, this case is specifically addressed, as any additional offsets to the spoofing profile are irrelevant to the monitor. The spoofer's uncertainty of target's position will simply be referred to as ‘tracking error’ herein. The tracking error appears in the spoofed measurements as an additive term, and the measurement equation can be represented as:

$${z}_{k}^{s} = {z}_{k} + {H}_{k} {v}_{k}^{t} \qquad ( 5 )$$

where

$${z}_{k}^{s}$$

is the spoofed measurement vector, zₖ is the ‘true’ (unspoofed) measurement vector, Hₖ is the observation matrix that maps the tracking error to the range domain, and

$${v}_{k}^{t}$$

is a n×1 column vector of tracking error with n being the number of states. The superscript s means spoofed.

These tracking errors can be observed in the KF innovation vector because it extracts the difference between the GNSS measurements and the predicted measurements of the process model from the INS. Even small deviations over time are readily observable using the INS due to the precision of GNSS carrier phase measurements.

Since the innovation vector γₖ is constructed from the entire measurement vector zₖ and the entire state vector x̅ₖ, the effect of the position tracking errors, our proxy for spoofing, will not be the only contributor to γₖ. A more direct way to observe the effect of the tracking errors would be to project the innovation vector into the position domain.

### 1.2 Neyman-Pearson Optimal and Sufficient Test Statistic

A test statistic to maximize the probability of detection for a given false alarm rate is desired. The Neyman-Person lemma provides the solution to this problem: given two mutually exclusive hypotheses H₀ and H₁, which for some observation x have conditional probability densities p₀(x|H₀) and p₁(x|H₁), the likelihood ratio is the optimal test statistic. The likelihood ratio is defined as:

$$Λ ( x ) = \frac{{p}_{1} ( x \vert {H}_{1} )}{{p}_{0} ( x \vert {H}_{0} )} \qquad ( 6 )$$

The two hypotheses are the fault-free case, where there is no tracking error, and the spoofed case, where tracking error appears in the innovation vector. As a starting point, the tracking error

$${v}_{k}^{t}$$

is modeled as white Gaussian noise (WGN) distributed as

$$𝒩 ( 0 , {σ}_{t}^{2} ) ,$$

where

$${σ}_{t}^{2}$$

is the unknown variance of the tracking error.

The innovation vector distributions are considered with and without the tracking error for our likelihood ratio test. The fault free innovation vector distribution at any time k is given as H₀: γₖ˜ [symbol] (0, Sₖ), while the spoofed innovation vector distribution as shown in Appendix C is given as

$${H}_{1} : {γ}_{k} ∼ 𝒩 ( 0 , {S}_{k} + {H}_{k} {RH}_{k}^{T} ) ,$$

where R=uu^{T}σₜ and u is a unit vector in an arbitrary spatial direction in which the tracking error exists. The innovation vectors are mutually independent over time under H₀. In principle they can also be modelled as independent under H₁ given that a ‘high quality’ IMU is being utilized. The reason is that x̅ₖ in equation would be relatively unaffected by the spoofer's tracking error using a high quality inertial.

Using equation (6), and given an arbitrary threshold λ(N) for independent innovations γₖ (k=1, . . . , N), the likelihood ratio test can be expressed as:

$$Λ ( {γ}_{1} , {γ}_{2} , … , {γ}_{N} ) = {C}_{1} ( N ) \frac{exp ( - \frac{1}{2} {\sum }_{k = 1}^{N} {{γ}_{k}^{T} ( {S}_{k} + {H}_{k} {RH}_{k}^{T} )}^{- 1} {γ}_{k} )}{exp ( - \frac{1}{2} {\sum }_{k = 1}^{N} {γ}_{k}^{T} {S}_{k}^{- 1} {γ}_{k} )} \begin{matrix}{H}_{1} \\ ≷ \\ {H}_{0}\end{matrix} λ ( N ) \qquad ( 7 )$$

$$where$$

$${C}_{1} ( N ) = {\prod }_{k = 1}^{N} {( \frac{\vert {S}_{k} \vert}{\vert {S}_{k} + {H}_{k} {RH}_{k}^{T} \vert} )}^{k / 2} \qquad ( 8 )$$

captures the terms that do not depend on γₖ(k=1, . . . , N). Taking natural log of both sides and collecting all the constant terms on the right:

$${\sum }_{k = 1}^{N} [ {γ}_{k}^{T} {S}_{k}^{- 1} {γ}_{k} - {{γ}_{k}^{T} ( {S}_{k} + {H}_{k} {RH}_{k}^{T} )}^{- 1} {γ}_{k} ] \begin{matrix}{H}_{1} \\ ≷ \\ {H}_{0}\end{matrix} 2 [ ln λ ( N ) - ln {C}_{1} ( N ) ] . \qquad ( 9 )$$

Also, because the matrices Sₖ and

$${S}_{k} + {H}_{k} R {H}_{k}^{T}$$

are nonsingular, can be written:

$${( {S}_{k} + {H}_{k} {RH}_{k}^{T} )}^{- 1} = {S}_{k}^{- 1} - \frac{{S}_{k}^{- 1} {H}_{k} {RH}_{k}^{T} {S}_{k}^{- 1}}{tr ( {H}_{k} {RH}_{k}^{T} {S}_{k}^{- 1} )} \qquad ( 10 )$$

Substituting equation (10) into (9):

$${\sum }_{k = 1}^{N} {γ}_{k}^{T} [ {S}_{k}^{- 1} - {S}_{k}^{- 1} + \frac{{S}_{k}^{- 1} {H}_{k} {RH}_{k}^{T} {S}_{k}^{- 1}}{tr ( {H}_{k} {RH}_{k}^{T} {S}_{k}^{- 1} )} ] {γ}_{k} \begin{matrix}{H}_{1} \\ ≷ \\ {H}_{0}\end{matrix} {C}_{2} ( N ) , \qquad ( 11 )$$

where the constant on the right side is:

$${C}_{2} ( N ) = 2 [ ln λ ( N ) - ln {C}_{1} ( N ) ] \qquad ( 12 )$$

For short periods of time, matrices H and S can be assumed to be time invariant, so the term

$$tr ( {H}_{k} {RH}_{k}^{T} {S}_{k}^{- 1} )$$

can be moved to the right side of equation (11). Equation (11) then reduces to:

$${\sum }_{k = 1}^{N} {γ}_{k}^{T} [ {S}^{- 1} {HRH}^{T} {S}^{- 1} ] {γ}_{k} \begin{matrix}{H}_{1} \\ ≷ \\ {H}_{0}\end{matrix} {C}_{3} ( N ) \qquad ( 13 )$$

$$where$$

$${C}_{3} ( N ) = {C}_{2} ( N ) tr ( {HRH}^{T} {S}^{- 1} ) \qquad ( 14 )$$

Recalling that R=uu^{T}σₜ, it is substituted into equation (13) to obtain:

$${\sum }_{k = 1}^{N} {γ}_{k}^{T} [ {S}^{- 1} {Huu}^{T} {σ}_{t} {H}^{T} {S}^{- 1} ] {γ}_{k} \begin{matrix}{H}_{1} \\ ≷ \\ {H}_{0}\end{matrix} {C}_{3} ( N ) \qquad ( 15 )$$

Re-arranging the terms of equation (15) and noting that S⁻¹ is symmetric:

$${\sum }_{k = 1}^{N} {( {u}^{T} {H}^{T} {S}^{- 1} {γ}_{k} )}^{T} ( {u}^{T} {H}^{T} {S}^{- 1} {γ}_{k} ) {{≷}_{{H}_{0}}}^{{H}_{1}} {C}_{4} ( N ) \qquad ( 16 )$$

where it is defined C₄(N)=C₃(N)/σₜ. Finally, the following scalar projection of the innovation vector is introduced:

$${γ}_{k}^{u} = {u}^{T} {H}^{T} {S}^{- 1} {γ}_{k} \qquad ( 17 )$$

which is a weighted projection of the innovation vector into the position domain direction u, the tracking error direction under consideration. Therefore, the optimal test statistic is:

$${q}_{N}^{u} = {\sum }_{k = 1}^{N} {( {γ}_{k}^{u} )}^{2} \qquad ( 18 )$$

which it is called the Cumulative Position-domain Innovation (CPI). Note that

$${q}_{N}^{u}$$

does not require knowledge of at.

### 1.3 Position Domain Innovation

Under spoof-free conditions, the scalar position domain innovation in equation (17) is distributed as:

$${γ}_{k}^{u} ∼ 𝒩 ( 0 , {u}^{T} {H}^{T} {S}^{- 1} H u ) \qquad ( 19 )$$

To simplify the notation, the variance is defined as:

$${σ}_{{γ}_{k}^{u}}^{2} = {u}^{T} {H}^{T} {S}^{- 1} H u \qquad ( 20 )$$

When the spoofer sends a signal mimicking the authentic signal with some inherent additive tracking error, the latter can be observed in the position domain innovation. The innovations for spoofed case with tracking error for an arbitrary spatial direction u is:

$${γ}_{k}^{s} = {γ}_{k} + H u {ν}_{k}^{t} \qquad ( 21 )$$

Substituting equation (21) for γₖ in equation (17), the spoofed position domain innovation is obtained:

$${γ}_{k}^{u s} = {u}^{T} {H}^{T} {S}^{- 1} ( {γ}_{k} + H {ν}_{k}^{t} ) = {γ}_{k}^{u} + {u}^{T} {H}^{T} {S}^{- 1} {H}^{T} u {ν}_{k}^{t} \qquad ( 22 )$$

The mean of

$${γ}_{k}^{u s}$$

is again zero but the variance is now:

$$𝔼 [ {( {γ}_{k}^{u s} )}^{2} ] = {u}^{T} {H}^{T} {S}^{- 1} H u + ( {u}^{T} {H}^{T} {S}^{- 1} H u ) {( {u}^{T} {H}^{T} {S}^{- 1} Hu )}^{T} {σ}_{t}^{2} \qquad ( 23 )$$

or more compactly using equation (20):

$$𝔼 [ {( {γ}_{k}^{u s} )}^{2} ] = {σ}_{{γ}_{k}^{u s}}^{2} = {σ}_{{γ}_{k}^{u}}^{2} + {σ}_{{γ}_{k}^{u}}^{4} {σ}_{t}^{2} \qquad ( 24 )$$

Thus, under spoofed conditions, the position domain innovation has the following distribution:

$${γ}_{k}^{u s} ∼ 𝒩 ( 0 , {σ}_{{γ}_{k}^{u}}^{2} + {σ}_{{γ}_{k}^{u}}^{4} {σ}_{t}^{2} ) \qquad ( 25 )$$

For notational simplicity, define:

$${σ}_{Δ {γ}_{k}^{u s}}^{2} = {σ}_{{γ}_{k}^{u}}^{4} {σ}_{t}^{2} \qquad ( 26 )$$

The tracking error affects the position domain innovation by increasing its variance without changing the mean (which remains zero). Now, the position domain innovation before and after spoofing are written, respectively, as:

$${γ}_{k}^{u} ∼ 𝒩 ( 0 , {σ}_{{γ}_{k}^{u}}^{2} ) \qquad ( 27 )$$

$${γ}_{k}^{u s} ∼ 𝒩 ( 0 , {σ}_{{r}_{k}^{u}}^{2} + {σ}_{Δ {γ}_{k}^{u s}}^{2} ) \qquad ( 28 )$$

When normalized by

$${σ}_{{γ}_{k}^{u}}$$

the position domain innovation is distributed in the unspoofed case as:

$$\frac{{γ}_{k}^{u}}{{σ}_{{γ}_{k}^{u}}} ∼ 𝒩 ( 0 , 1 ) \qquad ( 29 )$$

and in the spoofed case as:

$$\frac{{γ}_{k}^{us}}{{σ}_{{γ}_{k}^{u}}} ∼ 𝒩 ( 0 , 1 + {σ}_{Δ {γ}_{k}^{us}}^{2} / {σ}_{{γ}_{k}^{u}}^{2} ) \qquad ( 30 )$$

### 1.4 Sum of Squares of Normalized Position Domain Innovations

The square of a scalar Normal random variable distributed as [symbol] (0,σ²) follows the Gamma distribution Γ

$$( \frac{1}{2} , 2 ) .$$

The Gamma distribution Γ(α,θ) is defined by its shape parameter α and scale parameter θ.

Therefore, the distribution of square of normalized position domain innovation in the unspoofed case can be written as:

$${( \frac{{γ}_{k}^{u}}{{σ}_{{γ}_{k}^{u}}} )}^{2} ∼ Γ ( \frac{1}{2} , 2 ) \qquad ( 31 )$$

and in the spoofed case as:

$${( \frac{{γ}_{k}^{us}}{{σ}_{{γ}_{k}^{u}}} )}^{2} ∼ Γ ( \frac{1}{2} , 2 ( 1 + {σ}_{Δ {γ}_{k}^{us}}^{2} / {σ}_{{γ}_{k}^{u}}^{2} ) ) \qquad ( 32 )$$

For a period of accumulation N, following the results in sections 1.2 and 1.3, the optimal CPI test statistic is defined (in the unspoofed case) as:

$${q}_{N}^{u} = {\sum }_{k = 1}^{N} {( \frac{{γ}_{k}^{us}}{{σ}_{{γ}_{k}^{u}}} )}^{2} \qquad ( 33 )$$

and note that the sum of independent Gamma distributed random variables is also Gamma distributed. The change in variance of the position domain innovations is assumed to be negligible over the accumulation period, i.e.,

$$\begin{matrix}{σ}_{{γ}^{u}} = {σ}_{{γ}_{1}^{u}} = {σ}_{{γ}_{2}^{u}} = … = {σ}_{{γ}_{N}^{u}} and {σ}_{{Δγ}^{us}} = {σ}_{{Δγ}_{1}^{us}} = {σ}_{Δ {γ}_{2}^{us}} = … \\ = {σ}_{Δ {γ}_{N}^{us}} .\end{matrix}$$

The test statistic in the unspoofed case is then Gamma distributed as follows:

$${q}_{N}^{u} ∼ Γ ( {\sum }_{k = 1}^{N} \frac{1}{2} , 2 ) = Γ ( \frac{N}{2} , 2 ) \qquad ( 34 )$$

For a given probability of false alarm P_{FA}, the threshold is determined as:

$${T}_{N} = {F}_{Γ}^{- 1} ( {P}_{FA} \vert \frac{N}{2} , 2 ) \qquad ( 35 )$$

where

$${F}_{Γ}^{- 1}$$

is the inverse CDF of the Gamma distribution. In the spoofed case, with the tracking error embedded in the test statistic:

$${q}_{N}^{us} = {\sum }_{k = 1}^{N} {( \frac{{γ}_{k}^{us}}{{σ}_{{γ}^{u}}} )}^{2} ∼ Γ ( {\sum }_{k = 1}^{N} \frac{1}{2} , 2 ( 1 + \frac{{σ}_{Δ {γ}^{us}}^{2}}{{σ}_{γ}^{{2}_{u}}} ) ) \qquad ( 36 )$$

Defining the ratio

$$Ω = \frac{{σ}_{Δ {γ}^{us}}^{2}}{{σ}_{{γ}^{u}}^{2}}$$

the above equation can be re-written as:

$${q}_{N}^{us} ∼ Γ ( \frac{N}{2} , 2 ( 1 + Ω ) ) \qquad ( 37 )$$

From equations (34) and (37) it is seen that tracking error causes the scale parameter of the test statistic distribution to change but does not affect the shape parameter, which remains same as in the unspoofed distribution. The probability of missed detection (i.e., of not detecting the tracking error) is:

$${P}_{MD} = γ ( \frac{N}{2} , \frac{{T}_{N}}{2 ( 1 + Ω )} ) / Γ ( \frac{N}{2} ) \qquad ( 38 )$$

where T_{N} is the threshold as defined in equation (35), γ(a,b) is the lower incomplete Gamma function:

$$γ ( a , b ) = {\int }_{0}^{b} {t}^{a - 1} {e}^{- t} dt \qquad ( 39 )$$

and Γ is the Gamma function: Γ(a)=γ(a, ∞).

### 1.5 Gaussian Approximation

For a Gamma distribution with shape parameter α and scale parameter θ, the mean and variance are αθ and αθ², respectively. In order to understand how the tracking error helps with detection, the large N approximation is taken for Gamma distribution:

$$Γ ( α , θ ) \approx 𝒩 ( αθ , {αθ}^{2} ) \qquad ( 40 )$$

Thus, the distributions of

$${q}_{N}^{u} and {q}_{N}^{u s}$$

can be approximated for large N, respectively as:

$${q}_{N}^{u} 𝒩 ( N , 2 N ) \qquad ( 41 )$$

$$and$$

$${q}_{N}^{us} \sim 𝒩 ( N ( 1 + Ω ) , 2 {N ( 1 + Ω )}^{2} ) \qquad ( 42 )$$

a modified test statistic is introduced:

$${\tilde{q}}_{N}^{( \cdot )} = \frac{{q}_{N}^{( \cdot )} - N}{\sqrt{2 N}} \qquad ( 43 )$$

The unspoofed distribution of this new test statistic is:

$${\tilde{q}}_{N}^{u} \sim 𝒩 ( 0 , 1 ) \qquad ( 44 )$$

and the spoofed test statistic distribution is:

$${\tilde{q}}_{N}^{us} \sim 𝒩 ( \sqrt{\frac{N}{2}} Ω , {( 1 + Ω )}^{2} ) \qquad ( 45 )$$

It is clear from the preceding two equations that the accumulated tracking error causes the mean of the test statistic distribution to grow as N increases while the variance of the distribution remains independent of N.

### 1.6 Tracking Error as Colored Noise

For clarity in the development so far, the tracking error is assumed to be WGN. But it is possible that the tracking sensor error could be time-correlated, or even that the spoofer would choose to filter the tracking sensor output to try to smooth out the errors to lower the possibility of detection.

To analyze the performance of the CPI monitor, the distribution of the test statistic needs to be determined in the case of colored tracking error. The tracking error is modeled as a zero-mean first order Gauss-Markov random process (GMRP) with time constant τₜ and variance σₜ². To the spoofer's advantage, any time delays that might be incurred in the filtering process are ignored.

Although the CPI monitor operates sequentially in time, to analyze the monitor performance it is more convenient to use a batch method for quadratic forms of random variables. Let X be an N×1 random vector distributed as X˜ [symbol] (0,Σ) and A be an arbitrary N×N symmetric matrix. Then the quadratic form Q(X)=X^{T}AX can be expressed as a linear combination of independent central Chi-Square variables Y:

$$Q ( X ) = {X}^{T} AX = {\sum }_{j = 1}^{N} {λ}_{j} {Y}_{j}^{2} \qquad ( 46 )$$

where λ₁, λ₂, . . . λ_{N} are the eigenvalues of Σ^{1/2}AΣ^{1/2}, Z=Σ^{1/2}X, Y=P^{T}Z and P is the orthonormal matrix of eigenvectors of E^{1/2}AΣ^{1/2}. The cumulative position domain innovation from time 1 to N in terms of X with Σ can be defined as:

$$\sum = I {σ}_{{γ}^{u}}^{2} + [ \begin{matrix}1 & {e}^{\frac{- Δ t}{{τ}_{t}}} & … & {e}^{\frac{- ( N - 1 ) Δ t}{{τ}_{t}}} \\ {e}^{\frac{- Δ t}{{τ}_{t}}} & 1 & ⋱ & ⋮ \\ ⋮ & ⋱ & 1 & {e}^{\frac{- Δ t}{{τ}_{t}}} \\ {e}^{\frac{- ( N - 1 ) Δ t}{{τ}_{t}}} & … & {e}^{\frac{- Δ t}{{τ}_{t}}} & 1\end{matrix} ] {σ}_{{Δγ}^{us}}^{2} \qquad ( 47 )$$

and matrix A as:

$$A = I / {σ}_{{γ}^{u}}^{2} \qquad ( 48 )$$

making Q(X) the sum of the squares of the normalized position domain innovations, which is our CPI test statistic defined in equation (36). For authentic signals, only the first term in equation (47) exists because the innovations under normal conditions are white

$${σ}_{Δ {γ}^{us}}^{2} = 0$$

In the case of spoofing, Q(X) includes the colored noise, and in light of equation (46), it will have a generalized Chi-squared distribution, whose CDF can be evaluated.

### Example 2. Solution Separation Monitor with Sequential Windows

The SS monitor measures the difference of position solutions between the potentially spoofed integrated INS/GNSS KF output \hat{x}_{KF}_{ₖ} and an ostensibly clean ‘coasting’ INS-only solution x̅_{C}_{ₖ}. The test statistic at any time k is defined as:

$${q}_{{SS}_{k}} = {u}^{T} ( {\hat{x}}_{{KF}_{k}} - {\overline{x}}_{{C}_{k}} ) \qquad ( 49 )$$

The variance for the test statistic is given by:

$${σ}_{{SS}_{k}}^{2} = {u}^{T} ( {\overline{P}}_{{C}_{k}} - {\hat{P}}_{{KF}_{k}} ) u \qquad ( 50 )$$

where \hat{P}_{KF}_{ₖ} and P_{C}_{ₖ} are the estimate error covariance matrices for \hat{x}_{KF}_{ₖ} and x̅_{C}_{ₖ}, respectively. The detection threshold for the test statistic can be obtained given a desired false alert requirement and inverse CDF of

$$𝒩 ( 0 , {σ}_{{SS}_{k}}^{2} ) .$$

After detection, if the INS coasting solution is known to be unaffected by earlier spoofing, navigation can continue by switching from \hat{x}_{KF}_{ₖ} to x̅_{C}_{ₖ}.

Because the SS monitor observes the instantaneous error between the tightly coupled INS/GNSS KF position solution and INS-only coasting solution, and the coasting covariance P̅_{c} drifts over time, the detection threshold will need to continually increase to maintain a constant false alert probability. Thus, as the coasting window length increases, SS spoofing detection performance will degrade, allowing slowly growing faults to go undetected. While this is obviously not a desirable performance characteristic, it is precisely over these increasing time windows that the CPI monitor will perform the best. Therefore, given the complementary nature of the two monitors, it is natural to consider running them in parallel, where the CPI monitor would detect slowly growing spoofing profiles and the SS faster growing faults.

For the CPI monitor there will be a minimum window length Nₘᵢₙ required to achieve a desired P_{MD}_{₊}. Here, the subscript ‘+’ designates the missed detection (integrity risk) requirement allocation for spoofing attacks lasting longer than Nₘᵢₙ. The CPI monitor threshold would be obtained using the false alert (continuity risk) allocation for the monitor, P_{FA}_{₊}. For shorter attack windows, the SS monitor will provide the means for detection with the allocated missed detection and false alert probabilities, P_{MD}_{_{−}} and P_{FA}_{_{−}}. Obviously, the sum of the two missed detection probabilities must be smaller than the total integrity risk allocated to undetected spoofing. The same is true for the sum of the two false alert probabilities relative to the total continuity risk allocated to spoofing monitoring.

The SS monitor can provide a protection level for spoofing in the spatial direction u as:

$${PL}_{k}^{u} = {k}_{FA \_} {σ}_{{SS}_{k}} + {k}_{MD \_} {σ}_{{C}_{k}} \qquad ( 51 )$$

$$where$$

$${σ}_{{C}_{k}}^{2} = {u}^{T} {P}_{{C}_{k}} u \qquad ( 52 )$$

and the multipliers k_{FA}_{_{−}} and k_{MD}_{_{−}} are determined from the SS false alert and missed detection requirement probability allocations. The SS detection threshold is k_{FA}_{_{−}}σ_{SS}_{ₖ}. The protection level will increase with the SS window length due to the growth in σ_{C}_{ₖ} over time.

The minimum run length Nₘᵢₙ for the CPI monitor sets the upper limit on the SS monitor time window. The combined monitor system is implemented using consecutive fixed-length windows of length Nₘᵢₙ (FIG. 2) with a SS monitor initialized at the beginning of each window and terminated at the end of each window. A new SS monitor window is opened at each new GNSS measurement epoch and closed Nₘᵢₙ epochs later. FIG. 2 illustrates the idea, showing (conceptual) PL. Because each window has its own INS-only solution (from the SS monitor), if spoofing is detected in a particular window at time td, the final INS/GNSS KF solution and associated PL from a prior window closed (without detection) any time before td can be safely used to initialize subsequent fault-free coasting.

At any given instance of time there will be a set number of monitor windows running, the false alert requirement allocation for each monitor can be equally divided among these monitor windows to determine the thresholds for each. This approach is conservative since the test statistic for the different monitors will be correlated, but it is easy to implement.

The maximum PL produced by any SS monitor will happen at the end of the window, k=Nₘᵢₙ, because INS coasting errors, σ_{C}_{ₖ}, will be largest at that point.

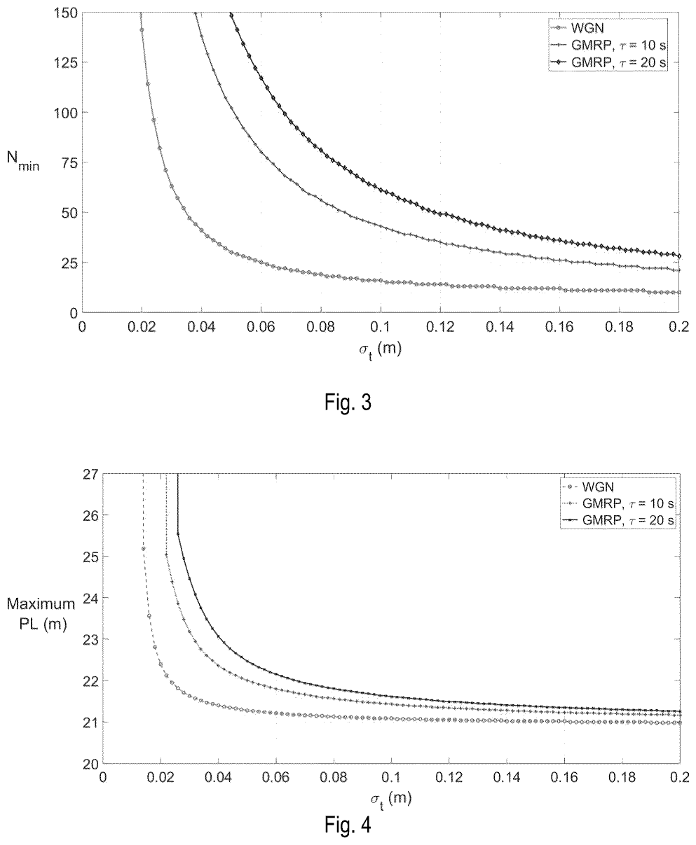

The value of Nₘᵢₙ is determined by the CPI monitor performance. FIG. 3 shows the values of Nₘᵢₙ for different tracking error magnitudes with the missed detection requirement set to 10⁻⁷. The figure shows the results for both white and colored Gaussian noise. It is clear that colored tracking error takes longer to detect than white noise. Using these values of Nₘᵢₙ, the maximum PLs can be determined. FIG. 4 shows the results for a false alarm requirement of 10⁻⁵ and missed detection requirement of 10⁻⁶ used in equation (51). Again, it is clear that WGN tracking error allows for tighter PLs compared to colored noise. The large SS PLs at small values of tracking error σ₀ are due to correspondingly large values of Nₘᵢₙ, which in turn lead to large coasting errors σ_{C}_{ₖ} (with k=Nₘᵢₙ). And for colored noise, a shorter time constant provides tighter protection level. Also, it can be seen that for decimeter-level tracking error magnitude, the maximum protection level converges regardless of whether the tracking error is time-correlated or not.

When implemented together, the CPI and SS monitors address all the limitations of the original CI monitor. The CPI monitor performs better than the CI monitor because its test statistic is optimized to detect tracking error. The addition of the SS monitor provides the means for detection of short duration spoofing and for exclusion of the spoofed solution after detection. The sequential implementation of the monitors ensures that performance is independent of the spoofing onset time.

Thus, the invention provides improved methods for detecting Global Navigation Satellite System (GNSS) spoofing. A cumulative position-domain innovation (CPI) monitor can detect spoofing by accumulating tracking error embedded in the spoofer's signal. Even with decimeter-level tracking error, the monitor can detect spoofing with low probability of missed detection in less than a minute.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for detecting Global Navigation Satellite System (GNSS) spoofing, comprising:
monitoring for tracking errors in GNSS signals during movement by comparing each of a plurality of the GNSS signals to a corresponding measurement from an auxiliary sensor, and determining accumulating discrepancies between the plurality of GNSS signals and the corresponding measurements from the auxiliary sensor.

2. The method of claim 1, further comprising computing and/or applying an optimal test statistic to check for discrepancies between the GNSS signals and measurements from the auxiliary sensor.

3. The method of claim 1, wherein the accumulating discrepancies comprises accumulated Kalman filter innovations projected into a position state domain.

4. The method of claim 1, further comprising alerting of a spoofing and/or disengaging a GNSS geolocation system upon the accumulating discrepancies reaching a predetermined threshold.

5. The method of claim 1, further comprising validating the each of the plurality of the GNSS signals until at least one discrepancy is determined between the plurality of GNSS signals and the corresponding measurements from the auxiliary sensor.

6. The method of claim 5, further comprising, upon validating a GNSS signal, implementing a monitoring window having a predetermined timeframe for a next of the plurality of the GNSS signals.

7. The method of claim 6, further comprising setting a window length as a function of predetermined missed detection probabilities, and implementing a solution separation between integrated GNSS-and-auxiliary-sensor solutions and auxiliary-sensor-only solutions over the window length.

8. The method of claim 6, further comprising setting sequences of overlapping windows, and applying a solution separation monitor to overlapping windows to determine the accumulating discrepancies.

9. The method of claim 1, wherein the auxiliary sensor comprises an inertial sensor, Lidar, an odometer, a vision or optical sensor, an ultra-wideband (UWB) sensor, an external clock, or combinations thereof.

10. A method for detecting Global Navigation Satellite System (GNSS) spoofing, comprising the steps of:
receiving GNSS signals;
acquiring measurements from at least one auxiliary sensor;
comparing a plurality of the GNSS signals with corresponding measurements from the at least one auxiliary sensor;
applying an optimal test statistic to determine discrepancies between the GNSS signals and the measurements from the auxiliary sensor; and
generating an alarm for possible GNSS spoofing upon reaching a predetermined threshold of accumulated discrepancies between the GNSS signals and the measurements from the auxiliary sensor.

11. The method of claim 10, wherein the at least one auxiliary sensor comprises an inertial sensor, Lidar, an odometer, a vision or optical sensor, an ultra-wideband (UWB) sensor, an external clock, or combinations thereof.

12. The method of claim 10, wherein the optimal test statistic comprises a Neyman-Pearson optimal test statistic.

13. The method of claim 10, further comprising applying a predetermined monitoring window to each of the plurality of GNSS signals, providing position domain protection levels of a specific window length to achieve desired missed detection probabilities, and implementing a solution separation between integrated GNSS-and-auxiliary-sensor solutions and auxiliary-sensor-only solutions over the specific window length.

14. The method of claim 13, wherein implementing the specific window length generates a sequence of overlapped windows, and wherein the solution separation begins inside the sequence of overlapped windows to provide the position domain protection levels.

15. The method of claim 10, wherein accumulating the discrepancies utilizes accumulated Kalman filter innovations projected into the position state domain.

16. A computational system for detecting GNSS spoofing, comprising:
a module for receiving GNSS signals and auxiliary sensor measurement signals;
at least one processor configured to compute an optimal test statistic based on comparing the GNSS signals with the auxiliary sensor measurement signals; and
at least one processor configured to determine whether the GNSS signal is a spoofing signal based upon accumulated discrepancies between the GNSS signals and the auxiliary sensor measurement signals exceeding a predetermined threshold.

17. The computational system of claim 16, further comprising means for providing position domain protection levels during the detection process.

18. The computational system of claim 16, further comprising means for providing post detection exclusion to ensure continuity of the navigation function.

19. The computational system of claim 16, further comprising a solution separation module configured to detect rapid-onset spoofing achieve protection levels in real time.

20. The computational system of claim 16, wherein the processors utilize accumulated Kalman filter innovations projected into the position state domain for monitoring.
